(19) United States
(12) Patent Application Publication
(10) Pub. No.: US 2003/0169027 A1
(43) Pub. Date: Sep. 11, 2003

(54) Switched- mode power supply

(76) Inventors: Wolfgang Croce, Graz (AT); G?uuml;nther Danhofer, Graz (AT)

Correspondence Address: D Douglas Price, Steptoe & Johnson, 1330 Conneticut Ave NW, Washington, DC, 20036, US

(21) Appl. No.: 10/257,279

(22) PCT Filed: Apr. 12, 2001
(86) PCT No.: PCT/AT01/00107

(30) Foreign Application Priority Data
Apr. 12, 2000 (AT) A 637/2000

(51) Int. Cl. G05F 1/40

(52) U.S. Cl. 323/286

(57) ABSTRACT

The invention relates to a switch-mode power supply comprising an input circuit (1) for periodically switching an input voltage (Uₑ) or an input current (Iₑ) on and off with a switching frequency (f_{S}), a transmission circuit (2) connected thereto, and an output circuit (3), which is connected to the latter and to which a load (4) can be connected. In order to provide a switch-mode power supply which has a smaller size and lower costs, compared with conventional switch-mode power supplies, it is provided that the transmission circuit (2) is formed by a bandpass filter (7), which is constructed from at least one capacitance (C) and at least one inductance (L) and whose resonant frequency (f₀) lies outside, in particular above, the switching frequency (f_{S}) of the input circuit (1). By omitting the transformer that is usually used, it is possible to avoid the disadvantages of said transformer. In order to obtain DC isolation, it is provided that, in each branch of the LC bandpass filter (7) at least one capacitor (C) is provided in series with the rest of the circuitry.

The invention relates to a switch-mode power supply comprising an input circuit for periodically switching an input voltage or an input current on and off at a switching frequency, a transmission circuit connected thereto, and an output circuit, which is connected to the latter and to which a load can be connected.

Switch-mode power supplies, which derive one or a plurality of DC or AC voltages of corresponding magnitude from the AC mains power supply, are necessary for supplying electronic devices. In conventional switch-mode power supplies, the voltage transformation and the DC isolation from the mains power supply that is usually demanded are performed by a transformer, which have a relatively large volume and weight and relatively high losses in relation to the entire circuit. With the aid of switch-mode power supplies, the mains power supply voltage is rectified and “chopped” with a relatively high frequency. By raising the operating frequency it is possible to greatly reduce the disadvantages of conventional power supplies with low-frequency transformers. By virtue of the higher operating frequency, it is possible to use smaller components having smaller absolute losses. This results in switch-mode power supplies which have a significantly smaller volume and a significantly lower weight compared with conventional power supplies. The switch-mode power supplies serve equally for converting DC or AC voltages into DC or AC voltages (from DC or AC into DC or AC).

Apart from the fact that DC isolation can be achieved with the aid of the transformers in the switch-mode power supplies, these components have a series of disadvantages. The transformers cause high losses and, when they are used, the risk of saturation due to asymmetrical driving must be prevented by corresponding circuits and methods, some of which are complicated. Compared with the miniaturized electronic components that are customary nowadays, transformers are still relatively large and heavy and, moreover, relatively expensive to produce even in the case of switch-mode power supplies. A further disadvantage that should be mentioned is the unavoidable leakage inductances which can give rise to, inter alia, overvoltages and thus impermissible loading of components of the switch-mode power supply or of connected circuits. Electronic circuits exhibit an inexorable trend toward higher frequencies. When using transformers, however, physical conditions mean that an increase in the magnetization frequency equivalent to the semiconductors has not been expected heretofore since the Weiss domains have to be aligned in the magnetic field (this gives rise to, for example, rotation losses of the magnetic material). By contrast, new materials and new fabrication methods in semiconductor technology mean that it is possible to see a much faster rise toward ever high limiting frequencies.

Known circuits usually have disadvantages with regard to short-circuit protection or overcurrent protection as well, since these protections can only be achieved by means of additional circuits or circuit sections, or must be dispensed with.

WO 94/06260 A1 discloses a ballast for a gas discharge lamp, which ballast contains a flyback converter and an invertor connected downstream, and no transformer. In order to reduce the switching losses and the disturbances radiated back into the mains power supply, the flyback converter contains a series and parallel resonant circuit in combination, which serve as energy buffer store. The switching losses of the power switch of the ballast are reduced by the power switch switching at a point in time at which the current through the power switch is minimal. However, DC isolation and short-circuit and overcurrent protection cannot be achieved with this circuit.

The object of the present invention is to develop a switch-mode power supply which can be used to reduce the disadvantages presented above. In particular, the circuit is intended to be distinguished by a smaller size, lower costs and higher protection compared with conventional switch-mode power supplies.

The object of the invention is achieved by virtue of the fact that the transmission circuit is formed by a bandpass filter (referred to as LC bandpass filter hereinafter) which is constructed from at least one capacitance and at least one inductance and whose resonant frequency lies outside the switching frequency of the input circuit. To a certain extent, a frequency-selective circuit is used instead of a transformer for transmitting the signal “chopped” by the input circuit. The LC bandpass filter effects peak current limiting by the sum of the impedances. The circuit according to the invention makes it possible to achieve a higher efficiency since the losses of the capacitors used are smaller than those of a transformer, and, moreover, the absolute losses of the inductances used are smaller due to the smaller structural size. The costs for the capacitors and coils of the bandpass filter used according to the invention are significantly lower than the production costs of a transformer. The disadvantageous leakage inductances in the coil, which is smaller than the transformer given the same power, are likewise smaller.

If the LC bandpass filter is dimensioned in such a way that its resonant frequency lies above the switching frequency of the input circuit, it is also possible to reduce the switch-off losses. If, before the next switching cycle, the capacitors are charged for the most part and, consequently, virtually no current flows anymore, the components of the switching stage, usually transistors, are switched off in a virtually currentless state, as a result of which the switch-off losses virtually disappear. The charging of the capacitors takes time, however, which is manifested in a lower maximum operating frequency and thus a lower power that can be transmitted. Therefore, it is necessary to make a compromise between the switch-off losses and the maximum operating frequency. If the LC bandpass filter is dimensioned in such a way that its resonant frequency lies below the switching frequency of the input circuit, the switch-off losses cannot be reduced.

In accordance with a further feature of the invention, the LC bandpass filter comprises a series circuit formed by at least one capacitor and at least one coil. This constitutes the simplest and thus also most cost-effective realization of the circuit according to the invention. In this case, the capacitor and the coil can, of course, be constructed from a plurality of individual components.

A symmetrical arrangement is obtained if the LC bandpass filter comprises two series circuits in each case formed by at least one capacitor and at least one coil, which series circuits are arranged in parallel between the input and the output of the transmission circuit, the values for the or each capacitor and the or each coil of each series circuit being essentially identical. This means that, on the one hand, the component loading is reduced and, on the other hand, DC isolation can be achieved. What is involved is frequency-selective DC isolation by a high-pass filter action of the capacitors. This is comparable to commercially available sheath current filters for antenna systems for eliminating ground loops, in which a coupling capacitance is used in the sheath of the antenna cable. In this case, energy is transmitted by the electrostatic field of the capacitors.

If, in the above case, the value of the resulting capacitor of each series circuit of the LC bandpass filter is less than or equal to 10 nF, the circuit can effect DC isolation without the use of a transformer while satisfying the customary legal safety requirements. The limit value of 10 nF for the coupling capacitance between primary side and secondary side can be gathered, for example, from relevant standards for medical-technical apparatuses. On account of the small amounts of charge due to the small capacitance, the arrangement satisfies the prerequisites for DC isolation. Above an operating frequency of a few kilohertz, a transformer is significantly larger, more expensive and more lossy, in contrast to capacitors of this type.

Further advantages can be obtained if at least one coil of the LC bandpass filter has an inductance that is variable as a function of time or current. In particular, the use of a so-called saturation coil, which, at the switch-on instant, has a high inductance and then a very low inductance, namely the saturation inductance, is advantageous since, as a result, the current rise is delayed at the beginning of a switching operation and, as a result, the switches, usually transistors, in the switching stage are switched on in an as far as possible currentless state, as a result of which the switching losses are reduced. After the switching operation, the coil attains saturation and allows the entire current to flow. The saturation coil is dimensioned by suitable selection of the magnetic core material, of the core volume and of the number of turns. The use of a saturation coil in series with a thyristor can be gathered from DE 33 34 794 A1 for example.

An increase in the operational reliability through as complete isolation as possible between the input side and output side of the circuit can be achieved if a low-pass filter is arranged at the input side of the input circuit, the limiting frequency of which low-pass filter is significantly less than the resonant frequency of the LC bandpass filter. In this case, the limiting frequency of the low-pass filter should be so much less than the resonant frequency of the bandpass filter that the attenuation of the transfer function in the stop band between low-pass filter and bandpass filter is as large as possible. In combination with the switch-mode power supply's bandpass filter according to the invention, it is possible to avoid the transmission of primary-side, high-frequency disturbance frequencies and transients to the secondary side and thus to the load. By virtue of the combination of the low-pass filter and the bandpass filter and the dimensioning thereof, an “independent” transmission of energy from the primary side to the secondary side cannot take place in any frequency range. By way of example, higher-frequency mains power supply disturbances lying in the passband of the bandpass filter can be effectively attenuated by the low-pass filter. The transmission of energy is made possible by the switching frequency of the input circuit, which “lifts” the frequency of the input signal into the passband of the LC bandpass filter. Without the input-side low-pass filter, input-side disturbance frequencies lying in the passband of the LC bandpass filter could be transmitted to the secondary side and there lead to damage to the load or the downstream circuits and to endangerment of persons and to impermissible transmissions of energy.

The features of the invention are explained in more detail with reference to the accompanying figures, which show schematic sketches for elucidating the invention and a preferred exemplary embodiment of a switch-mode power supply according to the invention.

In the figures:

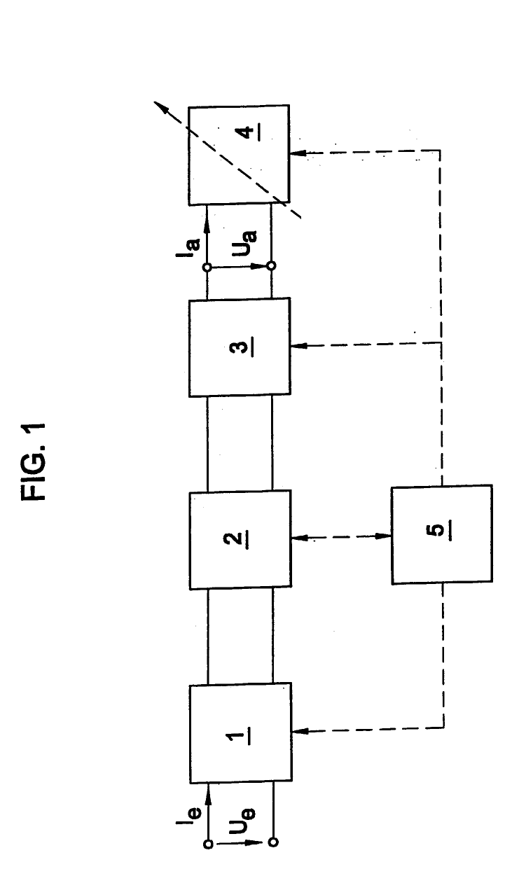

FIG. 1 shows the basic block diagram of a switch-mode power supply,

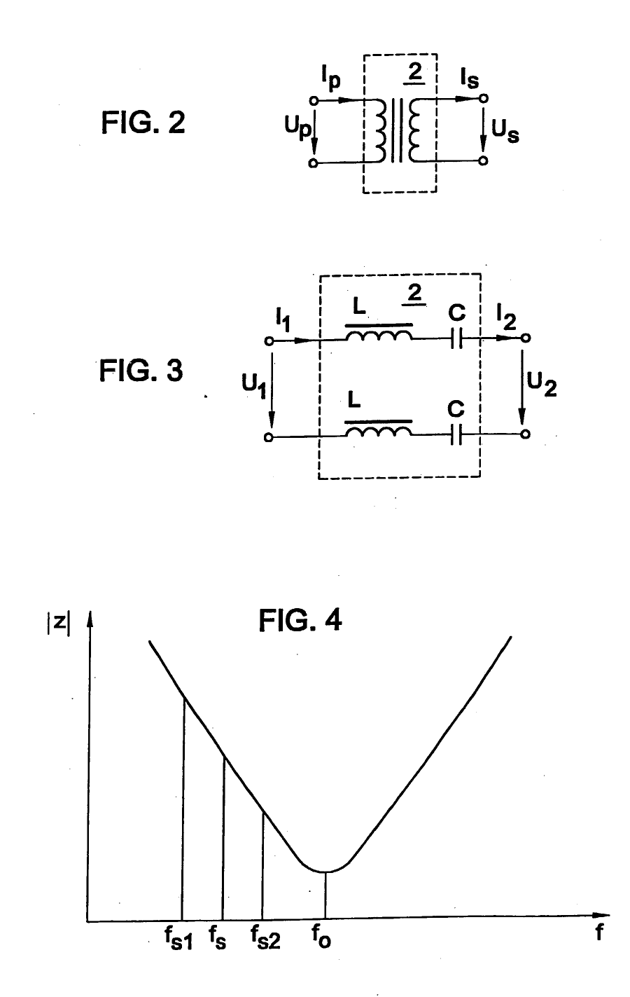

FIG. 2 shows the customary embodiment of the transmission device of a switch-mode power supply in the form of a transformer,

FIG. 3 shows the invention's embodiment of the transmission device of a switch-mode power supply in the form of an LC bandpass filter,

FIG. 4 shows the basic profile of the impedance of an LC bandpass filter as a function of frequency,

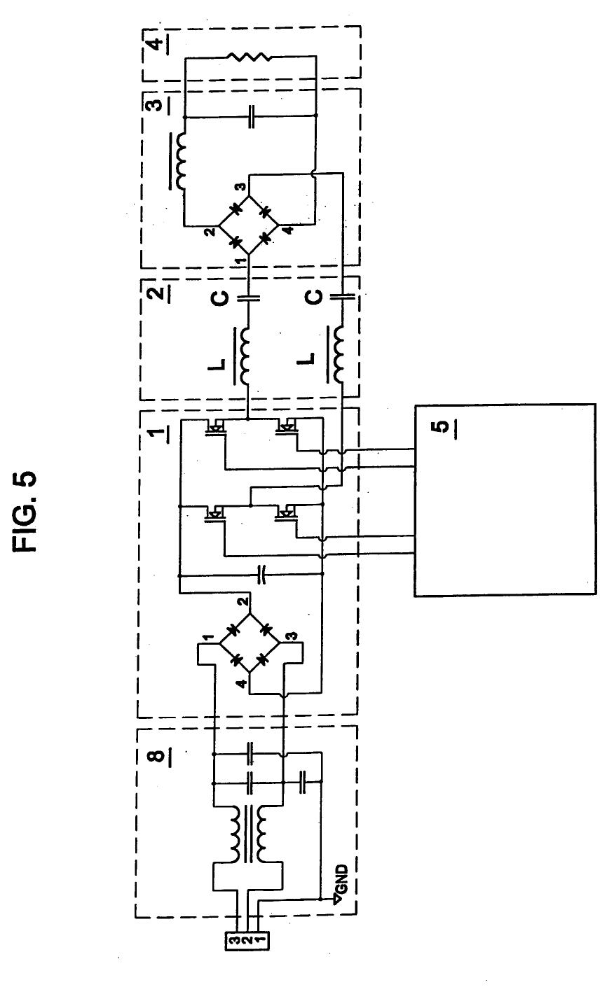

FIG. 5 shows the circuit diagram of an advantageous embodiment of a switch-mode power supply according to the invention,

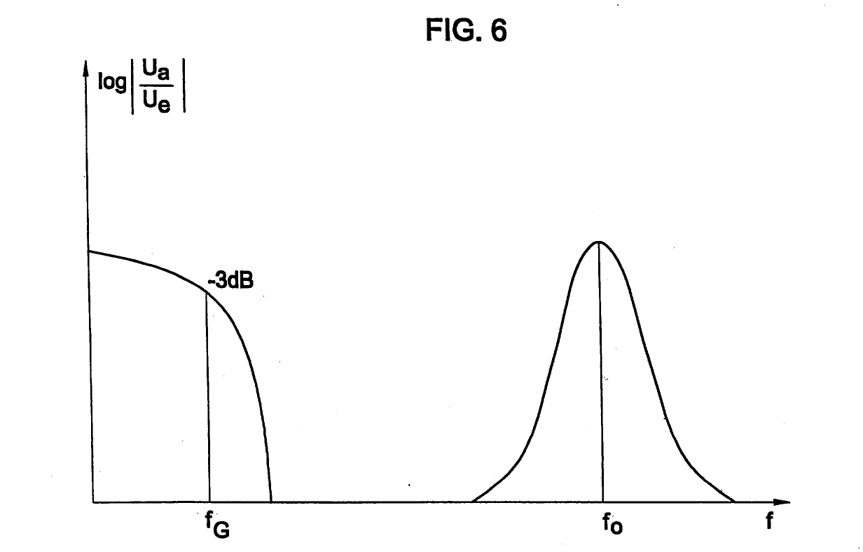

FIG. 6 shows the basic transfer function of the circuit in accordance with FIG. 5 as a function of frequency, and

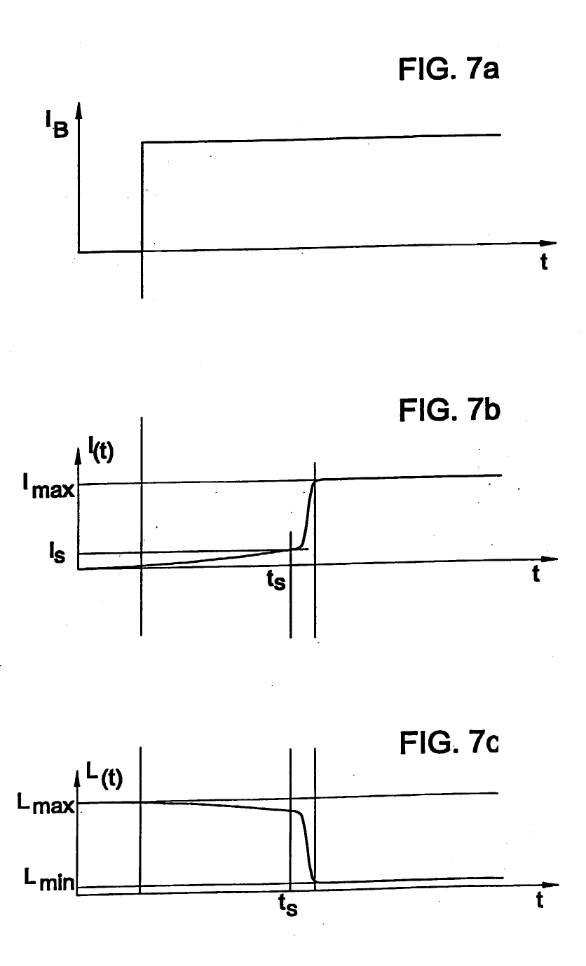

FIGS. 7a to 7c show the time profiles of a switching current through a saturation inductor and the inductance thereof during a switch-on operation.

FIG. 1 represents a basic block diagram of a switch-mode power supply. After any transformers or rectifiers (not illustrated), an input signal is present in the form of an input voltage Uₑ or an input current Iₑ, which is, “chopped” in an input circuit 1. For this purpose, the input circuit 1 is connected to a control circuit 5, in which the frequency with which the input signal is “chopped” is generated or defined. In a transmission circuit 2, the quantity supplied by the input circuit 1 is transformed, or transmitted, into a corresponding quantity. The transmission circuit 2 generally comprises a transformer (see FIG. 2). Afterward, in the output circuit 3, the electrical signal is subjected to further conditioning, for example rectification and filtering, before the signal is applied to the respective load 4. The switch-mode power supply can furthermore be regulated by means of the control circuit 5, so that a specific output voltage Uₐ or a specific output current Iₐ or a desired output power Pₐ occurs at the load 4, independently of the input signal. The load 4 may also be variable, as indicated.

FIG. 2 shows the conventional case of the use of a transformer 6 as transmission circuit 2 of a switch-mode power supply in accordance with FIG. 1. With the aid of the transformer 6, a primary voltage U_{P} or a primary current I_{P} is converted into a secondary voltage U_{S} or a secondary current I_{S}, respectively.

FIG. 3 illustrates the invention's embodiment of the transmission circuit 2 of the switch-mode power supply in the form of an LC bandpass filter 7. In the embodiment shown, the LC bandpass filter 7 comprises two series circuits formed in each case by a capacitor C and a coil L in each case of the same magnitude. In the simplest embodiment, the transmission circuit 2 comprises a series circuit formed by a capacitor C and a coil L. Higher-order LC bandpass filters or series or parallel circuits of inductances or capacitances for current or voltage division are also possible. According to the invention, the values for the capacitors C and coils L are defined in such a way that the resonant frequency fo of the bandpass filter, which resonant frequency is defined by the capacitors C and coils L, lies outside the switching frequency f_{S} of the input circuit 1 of the switch-mode power supply. The invention's realization of the transmission circuit 2 can also be considered as a series resonant circuit which is operated outside its resonant frequency f₀, resulting in a frequency-dependent impedance of the transmission circuit 2.

The invention's realization of the transmission circuit 2 in the form of an LC bandpass filter 7 makes it possible to avoid the transformer that is usually used. The disadvantages of a transformer, such as high losses, large volume, high weight and high production costs, are also obviated as a result. The LC bandpass filter 7 in accordance with FIG. 3 comprises two series circuits formed in each case by a capacitive and an inductive reactance. The coil L limits the peak current during switch-on. The charging capacitor C, by contrast, defines the energy that can be transmitted, that is to say further transmission of the energy is prevented after the capacitor C has been completely charged. Therefore, this combination of C and L in a series circuit is absolutely necessary. The coil L brings about a soft starting of the current and thus limits the switch-on losses. The capacitor C and the coil L have significantly lower losses compared with a transformer. At high frequencies, in particular, the advantages of the circuit according to the invention compared with the application of a transformer become particularly clear. If the component values in each series circuit are of essentially the same magnitude, the component loading is minimized. Although an asymmetrical arrangement effects different component loadings, it can also be advantageous. Thus, by way of example, it is possible to provide a saturation coil only in one branch, and the switch-on losses can be reduced by said coil. Instead of two series circuits formed by a capacitor C and a coil L, in theory one would also suffice, although then there would not be the associated advantage of DC isolation.

The invention's realization of the transmission circuit 2 is a series resonant circuit whose total impedance has a real profile as a function of frequency in accordance with FIG. 4. At a resonant frequency f₀, the impedance is at a minimum, and even equal to zero in theory in the lossless case. However, the concrete application is not a series resonant circuit in the conventional sense since an oscillation is not desired, and is actually not possible due to the external circuitry. Rather, the series circuit formed by the capacitor C and the coil L is operated outside the resonant frequency f₀, thereby enabling the impedance to be controlled by a change in the frequency f. In conjunction with the load resistance, the circuit can be regarded as a frequency-controlled voltage divider. In this case, it is advantageous if the operating frequency is chosen to be less than the resonant frequency f₀. It is possible to vary the output power by varying the switching frequency f_{S} in a specific frequency range f_{S1} to f_{S2}.

FIG. 5 shows an advantageous embodiment of a switch-mode power supply according to the invention. Arranged on the input side is a low-pass filter 8, which suppresses higher-frequency disturbances. This is followed by the input circuit 1 comprising a rectifier and the chopper, driven by a control circuit 5. The transmission circuit 2 comprises an LC bandpass filter formed from two series circuits each comprising a capacitor C and an inductance L. On the output side, a load 4 is connected downstream of an output circuit 3, which in this case is formed by a rectifier and a low-pass filter.

FIG. 6 shows the basic transfer function of the circuit in accordance with FIG. 5 as a function of frequency f. In this case, the limiting frequency f_{G} of the low-pass filter 8 is significantly less than the resonant frequency f₀ of the LC bandpass filter of the transmission circuit 2, so that undesirable disturbances are adequately attenuated in the stop band of the low-pass filter 8.

FIGS. 7a to 7c show the time profiles of a switching current through a saturable inductor and the inductance thereof during a switch-on operation. FIG. 7a outlines a switch-on operation, for example the base current of a transistor as electronic switch. FIG. 7b outlines the corresponding time profile of the current I(t) through a saturation coil L(t) and FIG. 7c the inductance L(t) of the saturation coil L(t) as a function of time t during the switch-on operation. After switch-on the current rises only very slowly through the relatively high inductance of the coil L(t). What can be achieved through appropriate dimensioning of the coil L(t) is that the coil L(t) attains saturation at a precisely defined current I_{S}, given by the operating voltage and the switch-on time that has already elapsed. The region of core saturation is characterized in that the magnetic flux cannot be appreciably increased despite an increase in the current in the coil L(t). In the region of saturation, approximately all of the elementary magnets of the core material are aligned in the preferred direction. In the region of saturation, the inductive reactance of the winding decreases, as a result of which only the undesirable resistive component of the reactance limits the current in the winding. Therefore, the inductance of the coil L(t) falls to a minimum value Lₘᵢₙ. The latter is determined principally by the number of turns and the core material of the coil L(t). By contrast, the current I(t) now rises more rapidly to its maximum value Iₘₐₓ limited by the load. The coil L(t) is preferably dimensioned by suitable selection of the magnetic core material, the number of turns and the core volume. These parameters influence not only the point in time t_{S} at which the coil L(t) attains saturation, but also the behavior with regard to how the transition to saturation takes place, i.e. for example the rate of current rise in the region of saturation of the coil L(t).

1. A switch-mode power supply comprising an input circuit (1) for periodically switching an input voltage (Uₑ) or an input current (Iₑ) on and off at a switching frequency (f_{S}), a transmission circuit (2) connected thereto, and an output circuit (3), which is connected to the latter and to which a load (4) can be connected, characterized in that the transmission circuit (2) is formed by a bandpass filter (7), which is constructed from at least one capacitance (C) and at least one inductance (L) and whose resonant frequency (f₀) lies outside the switching frequency (f_{S}) of the input circuit (1).

2. The switch-mode power supply as claimed in claim 1, characterized in that the resonant frequency (f₀) of the LC bandpass filter (7) lies above the switching frequency (f_{S}) of the input circuit (1).

3. The switch-mode power supply as claimed in claim 1 or 2, characterized in that the LC bandpass filter (7) comprises a series circuit formed by at least one capacitor (C) and at least one coil (L).

4. The switch-mode power supply as claimed in one of claims 1 to 3, characterized in that the LC bandpass filter (7) comprises two series circuits in each case formed by at least one capacitor (C) and at least one coil (L), which series circuits are arranged in parallel between the input and the output of the transmission circuit (2), the values for the or each capacitor (C) and the or each coil (L) of each series circuit being essentially of the same magnitude.

5. The switch-mode power supply as claimed in claim 4, characterized in that the value of the resulting capacitor (C) of each series circuit of the LC bandpass filter (7) is less than or equal to 10 nF.

6. The switch-mode power supply as claimed in one of claims 1 to 4, characterized in that at least one coil (L) of the LC bandpass filter (7) has an inductance (L(t)) that is variable as a function of time or current.

7. The switch-mode power supply as claimed in one of claims 1 to 6, characterized in that a low-pass filter (8) is arranged at the input side of the input circuit (1), the limiting frequency (f_{G}) of which low-pass filter is significantly less than the resonant frequency (f₀) of the LC bandpass filter (7).
